(19) United States
(12) Patent Application Publication
(10) Pub. No.: US 2015/0197281 A1
(43) Pub. Date: Jul. 16, 2015

(54) TRAILER BACKUP ASSIST SYSTEM WITH LANE MARKER DETECTION

(71) Applicant: Ford Global Technologies, LLC, Dearborn, MI (US)

(72) Inventors: Alex Maurice Miller, Canton, MI (US); Michael Hafner, Ann Arbor, MI (US); Sudipto Aich, Palo Alto, CA (US)

(73) Assignee: Ford Global Technologies, LLC

(21) Appl. No.: 14/667,940

(22) Filed: Mar. 25, 2015

Related U.S. Application Data
(63) Continuation-in-part of application No. 14/627,758, filed on Feb. 20, 2015.
Application No. 14/627,758 is a continuation-in-part of application No. 14/257,384, filed on Apr. 21, 2014.
Application No. 14/257,384 is a continuation-in-part of application No. 14/256,427, filed on Apr. 18, 2014.
Application No. 14/256,427 is a continuation-in-part of application No. 14/249,781, filed on Apr. 10, 2014.
Application No. 14/249,781 is a continuation-in-part of application No. 14/188,213, filed on Feb. 24, 2014.
Application No. 14/188,213 is a continuation-in-part of application No. 13/847,508, filed on Mar. 20, 2013.
Application No. 13/847,508 is a continuation-in-part of application No. 14/068,387, filed on Oct. 31, 2013.
Application No. 14/068,387 is a continuation-in-part of application No. 14/059,835, filed on Oct. 22, 2013.
Application No. 14/059,835 is a continuation-in-part of application No. 13/443,743, filed on Apr. 10, 2012, now Pat. No. 8,825,328.
Application No. 13/443,743 is a continuation-in-part of application No. 13/336,060, filed on Dec. 23, 2011, now Pat. No. 8,909,426.
Application No. 14/249,781 is a continuation-in-part of application No. 14/161,832, filed on Jan. 23, 2014.
Application No. 14/161,832 is a continuation-in-part of application No. 14/059,835, filed on Oct. 22, 2013.
Application No. 14/249,781 is a continuation-in-part of application No. 14/201,130, filed on Mar. 7, 2014.
Application No. 14/201,130 is a continuation-in-part of application No. 14/068,387, filed on Oct. 31, 2013.
(60) Provisional application No. 61/477,132, filed on Apr. 19, 2011.

(51) Int. Cl. B62D 13/06

(52) U.S. Cl. CPC B62D 13/06

(57) ABSTRACT

A system for backing a vehicle and a trailer is provided herein. The system includes an imaging system configured to detect contiguous lane markers while imaging an operating environment of the vehicle and trailer. The system also includes a user interface configured to display the contiguous lane markers in relation to the vehicle and trailer wherein the user is enabled to select a target space bounded by the contiguous lane markers. A backup assist system is also provided to determine a steering trajectory into the target space.

### CROSS-REFERENCE TO RELATED APPLICATIONS

This patent application is a continuation-in-part of U.S. patent application Ser. No. 14/627,758 which was filed on Feb. 20, 2015, entitled “TRAILER BACKUP ASSIST SYSTEM WITH WAYPOINT SELECTION,” which is a continuation-in-part of U.S. patent application Ser. No. 14/257,384 which was filed on Apr. 21, 2014, entitled “TRAILER BACKUP ASSIST SYSTEM WITH TRAJECTORY PLANNER FOR MULTIPLE WAYPOINTS,” which is a continuation-in-part of U.S. patent application Ser. No. 14/256,427, which was filed on Apr. 18, 2014, entitled “CONTROL FOR TRAILER BACKUP ASSIST SYSTEM,” which is a continuation in part of U.S. patent application Ser. No. 14/249,781, which was filed on Apr. 10, 2014, entitled “SYSTEM AND METHOD FOR CALCULATING A HORIZONTAL CAMERA TO TARGET DISTANCE,” which is a continuation-in-part of U.S. patent application Ser. No. 14/188,213, which was filed on Feb. 24, 2014, entitled “SENSOR SYSTEM AND METHOD FOR MONITORING TRAILER HITCH ANGLE,” which is a continuation-in-part of U.S. patent application Ser. No. 13/847,508, which was filed on Mar. 20, 2013, entitled “HITCH ANGLE ESTIMATION.” U.S. patent application Ser. No. 14/188,213 is also a continuation-in-part of U.S. patent application Ser. No. 14/068,387, which was filed on Oct. 31, 2013, entitled “TRAILER MONITORING SYSTEM AND METHOD,” which is a continuation-in-part of U.S. patent application Ser. No. 14/059,835, which was filed on Oct. 22, 2013, entitled “TRAILER BACKUP ASSIST SYSTEM,” which is a continuation-in-part of U.S. patent application Ser. No. 13/443,743 which was filed on Apr. 10, 2012, now U.S. Pat. No. 8,825,328, entitled “DETECTION OF AND COUNTERMEASURES FOR JACKKNIFE ENABLING CONDITIONS DURING TRAILER BACKUP ASSIST,” which is a continuation-in-part of U.S. patent application Ser. No. 13/336,060, which was filed on Dec. 23, 2011, now U.S. Pat. No. 8,909,426, entitled “TRAILER PATH CURVATURE CONTROL FOR TRAILER BACKUP ASSIST,” which claims benefit of U.S. Provisional Patent Application No. 61/477,132, which was filed on Apr. 19, 2011, entitled “TRAILER BACKUP ASSIST CURVATURE CONTROL.” U.S. patent application Ser. No. 14/249,781 is also a continuation-in-part of U.S. patent application Ser. No. 14/161,832 which was filed Jan. 23, 2014, entitled “SUPPLEMENTAL VEHICLE LIGHTING SYSTEM FOR VISION BASED TARGET DETECTION,” which is a continuation-in-part of U.S. patent application Ser. No. 14/059,835 which was filed on Oct. 22, 2013, entitled “TRAILER BACKUP ASSIST SYSTEM.” Furthermore, U.S. patent application Ser. No. 14/249,781 is a continuation-in-part of U.S. application Ser. No. 14/201,130 which was filed on Mar. 7, 2014, entitled “SYSTEM AND METHOD OF CALIBRATING A TRAILER BACKUP ASSIST SYSTEM,” which is a continuation-in-part of U.S. patent application Ser. No. 14/068,387, which was filed on Oct. 31, 2013, entitled “TRAILER MONITORING SYSTEM AND METHOD.” The aforementioned related applications are hereby incorporated by reference in their entirety.

### FIELD OF THE INVENTION

The present invention generally relates to trailer backup assist systems, and more particularly, to a system and method for backing a vehicle and trailer into a target space bounded by contiguous lane markers.

### BACKGROUND OF THE INVENTION

Backing a vehicle while towing a trailer can be very challenging for many drivers, especially those who tow trailers infrequently. Oftentimes, a driver may be required to execute a backup maneuver into a target space bounded by contiguous lane markers. Such spaces commonly appear in parking lots, rest stations, and the like. As a result, a driver may find it difficult to maneuver a vehicle and trailer due to the presence of other vehicles and objects. Thus, there is a need for a system that is capable of semi-autonomously executing a backing maneuver into a target space bounded by contiguous lane markers.

### SUMMARY OF THE INVENTION

According to one aspect of the present invention, a system for backing a vehicle and trailer is provided. An imaging system is configured to detect contiguous lane markers while imaging an operating environment of the vehicle and trailer. A user interface is configured to display the contiguous lane markers in relation to the vehicle and trailer and enable a user to select a target space bounded by the contiguous lane markers. A backup assist system is configured to determine a steering trajectory into the target space.

According to another aspect of the present invention, a system for backing a vehicle and trailer is provided. An imaging system is configured to detect contiguous lane markers while imaging an operating environment of the vehicle and trailer. A backup assist system is configured to determine a steering trajectory into a target space bounded by contiguous lane markers, wherein the backup assist system is further configured to automatically steer the vehicle while a backing maneuver is executed into the selected target space.

According to yet another aspect of the present invention, a method for backing a vehicle and trailer is provided. The method includes the steps of: imaging an operating environment of the vehicle and trailer; analyzing captured images to detect contiguous lane markers; displaying contiguous lane markers on a user interface; selecting a target space bounded by contiguous lane markers; determining a steering trajectory into the selected target space; and automatically steering the vehicle while executing a backing maneuver into the selected target space.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 illustrates a schematic diagram of a vehicle and trailer according to one embodiment;

FIG. 2 illustrates a schematic diagram of a vehicle and trailer being driven in an operating environment according to one embodiment;

FIG. 3 illustrates a flow chart of a method for backing a vehicle and trailer into a target space according to one embodiment;

FIG. 4 illustrates contiguous lane markers being detected by a vehicle and trailer driving along a path according to one embodiment;

FIG. 5 illustrates a user interface displaying the position of the vehicle and trailer in relation to detected contiguous lane markers according to one embodiment;

FIG. 6 illustrates valid spaces in which to execute a backing maneuver for a vehicle and trailer according to one embodiment;

FIG. 7 illustrates a touchscreen registering a touch even for selecting a target space in which to execute a backing maneuver for a vehicle and trailer according to one embodiment;

FIG. 8 illustrates a steering trajectory of a backing maneuver into a selected target space according to one embodiment;

FIG. 9 illustrates a vehicle and trailer backing into a selected target space along a steering trajectory according to one embodiment; and

FIG. 10 illustrates the completion of a backing maneuver according to one embodiment in which a vehicle and trailer are stopped inside a selected target space.

### DETAILED DESCRIPTION OF THE PREFERRED EMBODIMENTS

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

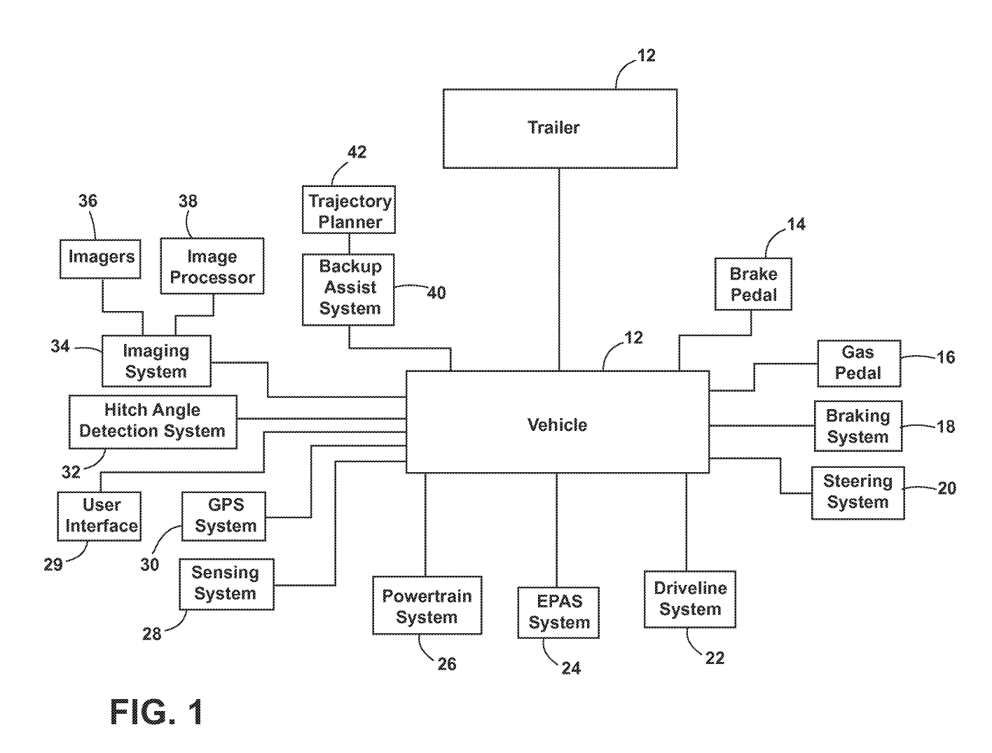

Referring to FIG. 1, a schematic diagram of a vehicle 10 and trailer 12 is shown according to one embodiment. The vehicle 10 includes at least the following equipment or systems: a brake pedal 14, a gas pedal 16, a braking system 18, a steering system 20, a driveline system 22, an electric power assisted steering (EPAS) system 24, a powertrain system 26, a sensing system 28, a GPS system 30, a user interface 29, a hitch angle detection system 32, an imaging system 34 having a plurality of imagers 36 (e.g., cameras) and an image processor 38, and a backup assist system 40 having a trajectory planner 42. It should be appreciated, however, that the vehicle 10 and trailer 12 described herein may include other suitable equipment or systems in lieu of those described above.

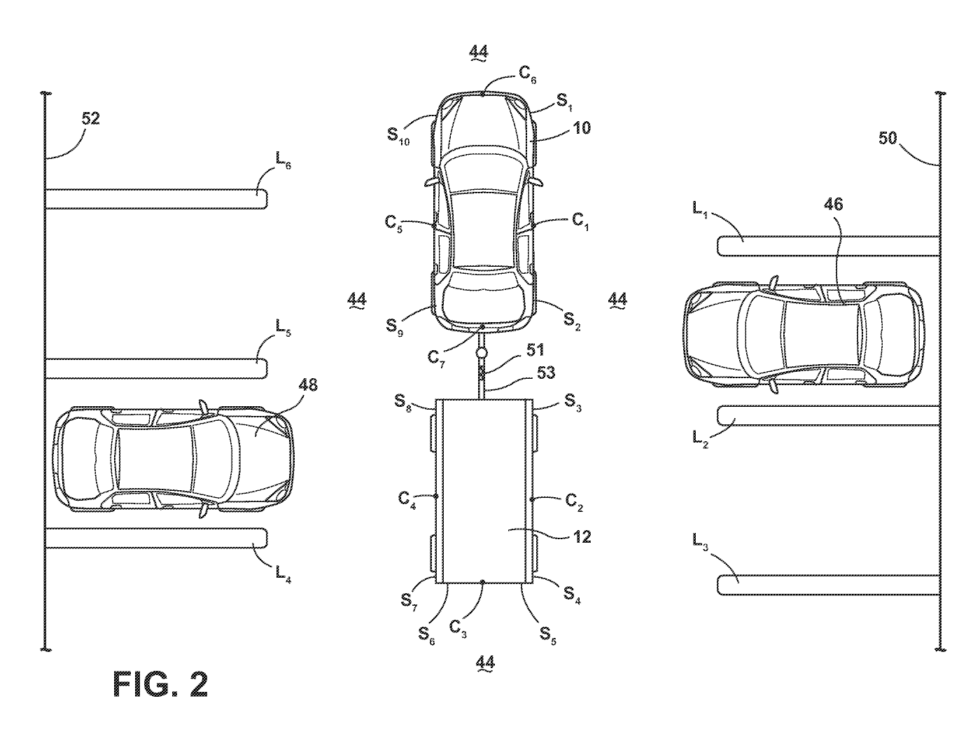

Referring to FIG. 2, the imaging system 34 may include cameras C₁-C₆ disposed variously on the front, sides, and rear of the vehicle 10 and trailer 12. For example, camera C₆ is configured to capture images of a forward vehicle scene; cameras C₁ and C₅ are configured to capture images of a side vehicle scene; cameras C₂ and C₄ are configured to capture images of a side trailer scene; and camera C₃ is configured to capture images of a rear trailer scene. However, it should be appreciated that the number and/or location of the cameras C1-C6 may be other than illustrated, if so desired. In operation, cameras C1-C6 image an operating environment 44 of the vehicle 10 and trailer 12 and captured images taken by cameras C1-C6 are analyzed by image processor 38 to detect contiguous lane markers (e.g., lane markers L1-L6) and their relative positions with respect to the vehicle 10 and trailer 12. As used herein, the term “contiguous lane markers” refers to lane markers that are near to or next to one another.

Referring still to FIG. 2, the sensing system 28 may include a plurality of ultrasonic sensors S1-S10 disposed variously along the front, sides, and rear of the vehicle 10 and trailer 12. In operation, ultrasonic sensors S1-S10 detect objects neighboring the vehicle 10 and trailer 12. Such objects may include other vehicles, shown as vehicles 46 and 48, as well as structural obstacles such as curbs 50 and 52. While the vehicle 10 and trailer 12 are moving through the operating environment 44, the hitch angle detection system 32 may continuously monitor the position of the trailer 12 relative to the vehicle 10. For example, the hitch angle detection system 32 may include a camera C7 configured to capture images of a rear vehicle scene containing a target 51 disposed on a trailer tongue 53. By tracking the position of the target 51, the hitch angle detection system 32 is able to calculate a hitch angle between the vehicle 10 and trailer 12, the hitch angle defined herein as the angle between the longitudinal axis of the vehicle 10 and the longitudinal axis of the trailer 12.

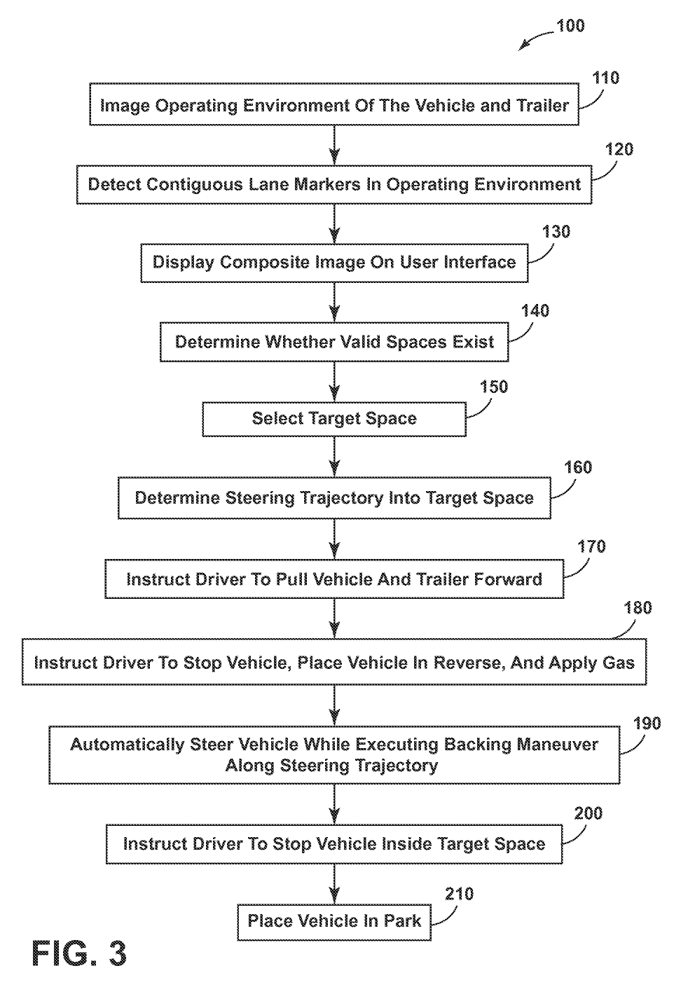

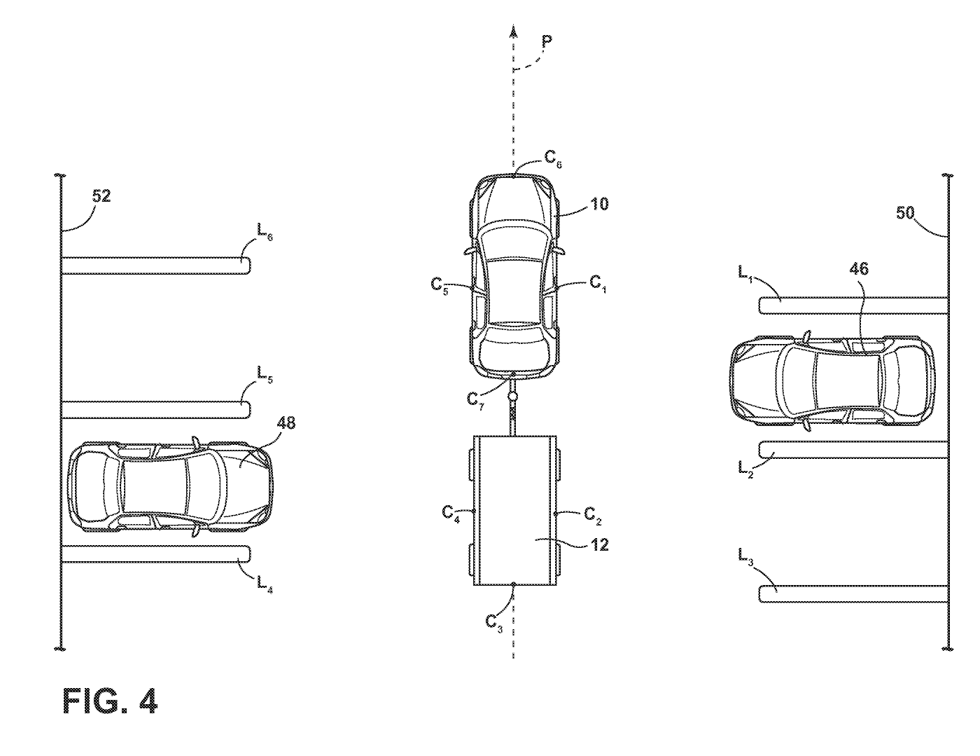

Referring to FIG. 3, a flow chart of a method 100 for backing the vehicle 10 and trailer 12 is shown according to one embodiment. For purposes of illustration, the method 100 will be described in reference to FIGS. 4-11, which together illustrate a series of steps for executing a backing maneuver into a target space.

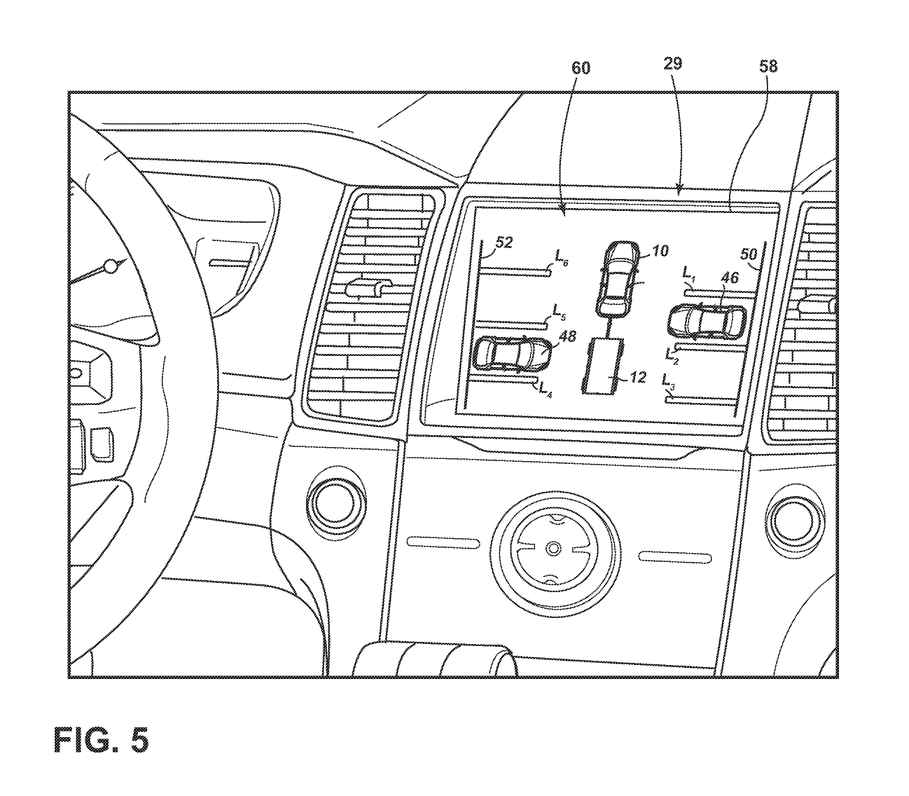

At steps 110 and 120, cameras C1-C6 image the operating environment 44 while the vehicle 10 and trailer 12 travel along path P at a slow rate of speed and the image processor 38 analyzes the captured images to detect contiguous lane markers L1-L6 and their positions in relation to the vehicle 10 and trailer 12 (FIG. 4). At step 130, image processor 38 uses image data from one or more of the cameras C-C6 to generate a composite image that is displayed on the user interface 29. As exemplarily shown in FIG. 5, the user interface 29 may include a touchscreen display 58 that is located in a vehicle cabin and is accessible to the driver of the vehicle 10. The composite image may correspond to a bird's eye view 60 showing the current position of the vehicle 10 and trailer 12 in relation to the detected lane markers L1-L6. Additionally, the composite image may also show the position of obstacles such as vehicles 46 and 48 and curbs 50 and 52. The obstacles may be detected using cameras C1-C6 and/or ultrasonic sensors S1-S10.

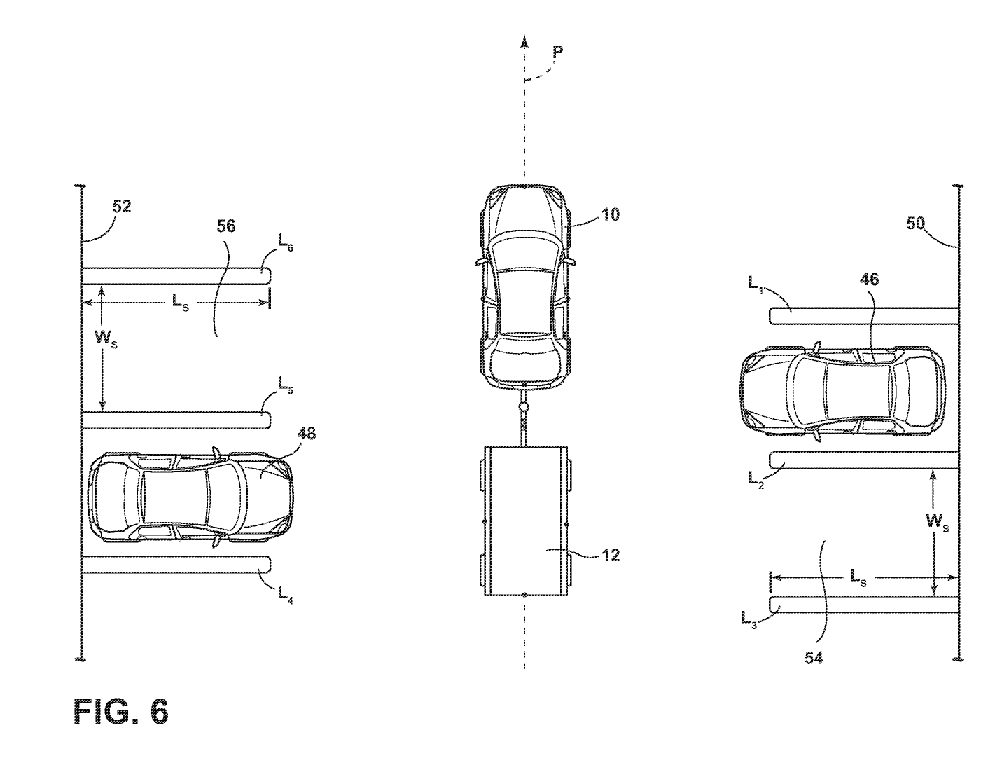

At step 140, and while the vehicle 10 and trailer 12 are still moving along path P, the trajectory planner 42 determines whether any valid spaces are present in which the vehicle 10 and trailer 12 can be backed into. As defined herein, a valid space is one that is bounded by contiguous lane markers and is presently unoccupied by another vehicle or other object. In addition, for a space to be valid, it should have a sufficient slot length and slot width to accommodate at least a portion of the vehicle 10 and trailer 12 if not the entirety. In determining whether a space is valid, the trajectory planner 42 may process information provided from the sensing system 28, the imaging system 34, and the known dimensions of the vehicle 10 and trailer 12. As exemplarily shown in FIG. 6, the trajectory planner 42 may determine that spaces 54 and 56 are valid, each having slot length Lₛ and slot width Wₛ, and wherein space 54 is bounded by contiguous lane markers L5 and L6 and space 56 is bounded by contiguous lane markers L1 and L2.

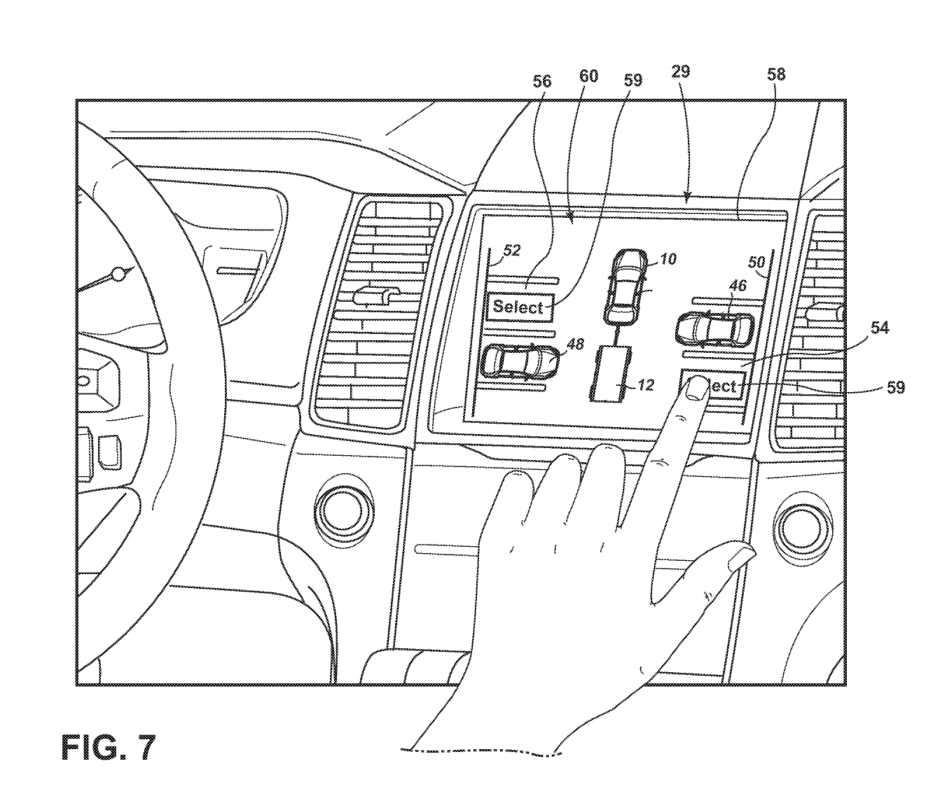

Once one or more valid spaces have been determined, the driver may select a target space in which to execute a backing maneuver for the vehicle 10 and trailer 12 at step 150. According to one embodiment, the driver selects the target space via the user interface 29. As exemplarily shown in FIG. 7, the composite image displayed on touchscreen display 58 may visually differentiate valid spaces, such as spaces 54 and 56, from invalid spaces, such as those occupied by other vehicles. Specifically, a box 59 may be generated in each of spaces 54 and 56 and the driver may select either one of spaces 54 and 56 to be the target space through one or more touch events. For instance, the driver may select space 56 as the target space by touching the corresponding box 59.

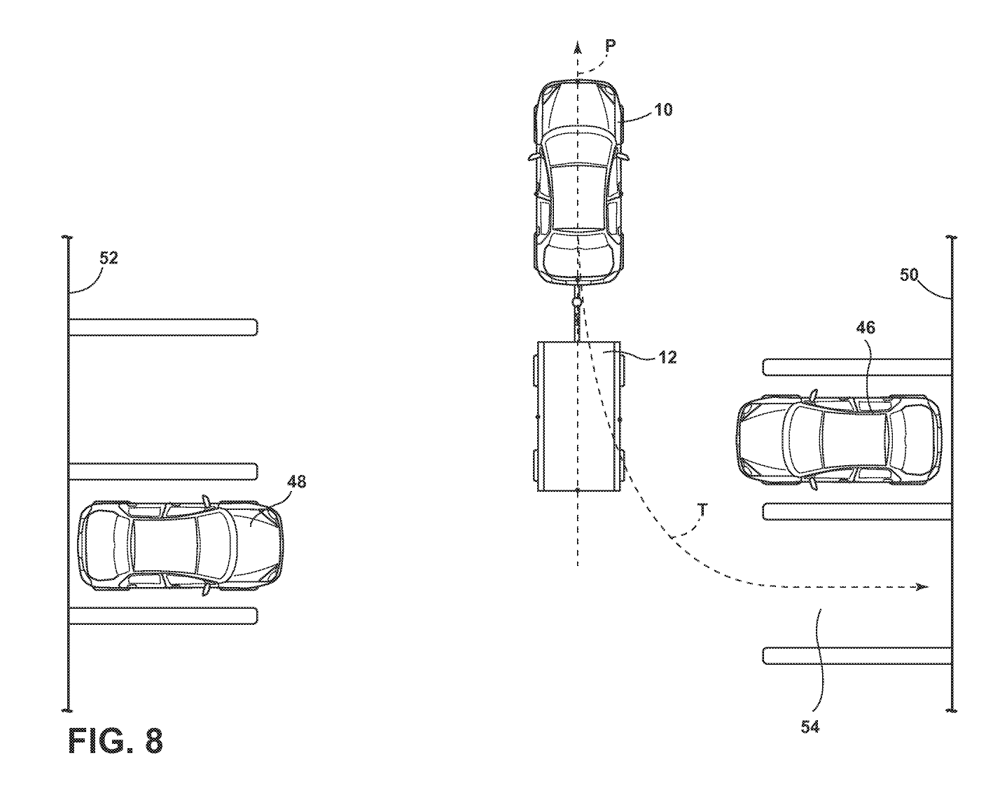

Once the driver has selected the target space, the trajectory planner 42 determines a steering trajectory T along which to execute the backing maneuver for the vehicle 10 and trailer 12 into the target space (e.g., space 54) at step 160 (FIG. 8). The determination of the steering trajectory T may be based on information received from sensing system 28, imaging system 34, GPS system 30, and known dimensions of the vehicle 10 and trailer 12. Additionally or alternatively, the trajectory planner may determine the steering trajectory based on information received from the imaging system 34 and/or the sensing system 28. For example, information received from the imaging system 34 and/or the sensing system 28 may be used to identify the relative position and orientation of the vehicle 10 and trailer 12 with respect to the target space. The positions of the vehicle 10, trailer 12, and target space may be represented in a localized coordinate system and the steering trajectory T may be generated within the localized coordinate system. As the backing maneuver is underway, information received from the imaging system 34 and/or sensing system 28 may be used to calculate where the vehicle 10 and trailer 12 are located relative to the target space. Additional sensors such as wheel sensors, steering wheel sensors, and the like, may also be used to determine the relative position and heading of the vehicle 10 and trailer with respect to the target space. Moreover, with respect to the embodiments described herein, the curvature of the steering trajectory T may be chosen to avoid causing a jackknife between the vehicle 10 and trailer 12. Furthermore, the trajectory planner 42 may also take into account the length and width of path P.

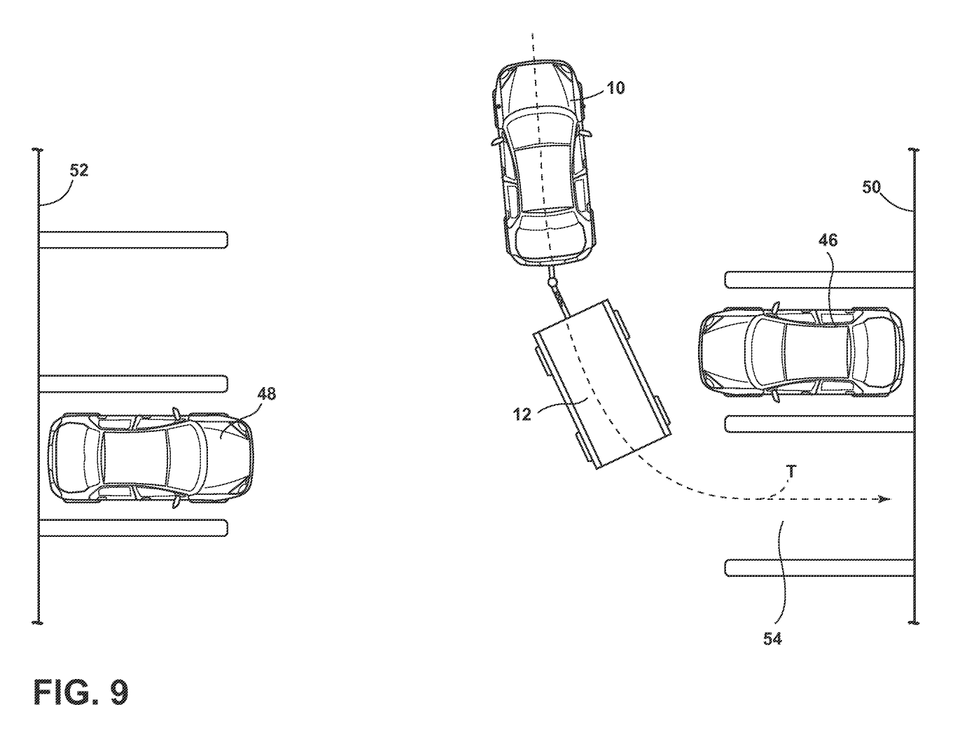

At step 170, the driver may be instructed to pull the vehicle 10 and trailer 12 forward in order to successfully execute the backing maneuver along the steering trajectory T. At step 180, the driver is instructed to stop the vehicle 10, place the vehicle 10 in reverse, and apply gas (e.g., depress gas pedal 16) the vehicle 10 to execute the backing maneuver along steering trajectory T (FIG. 9). Instructions to the driver may include visual notifications such as text messages appearing on a display inside the vehicle 10, auditory notifications, haptic notifications, and/or other sensory notifications. While the vehicle 10 and trailer 12 are backed along the steering trajectory T, the backup assist system 40 automatically steers the vehicle 10, thereby maintaining the vehicle 10 and trailer 12 along the steering trajectory T at step 190.

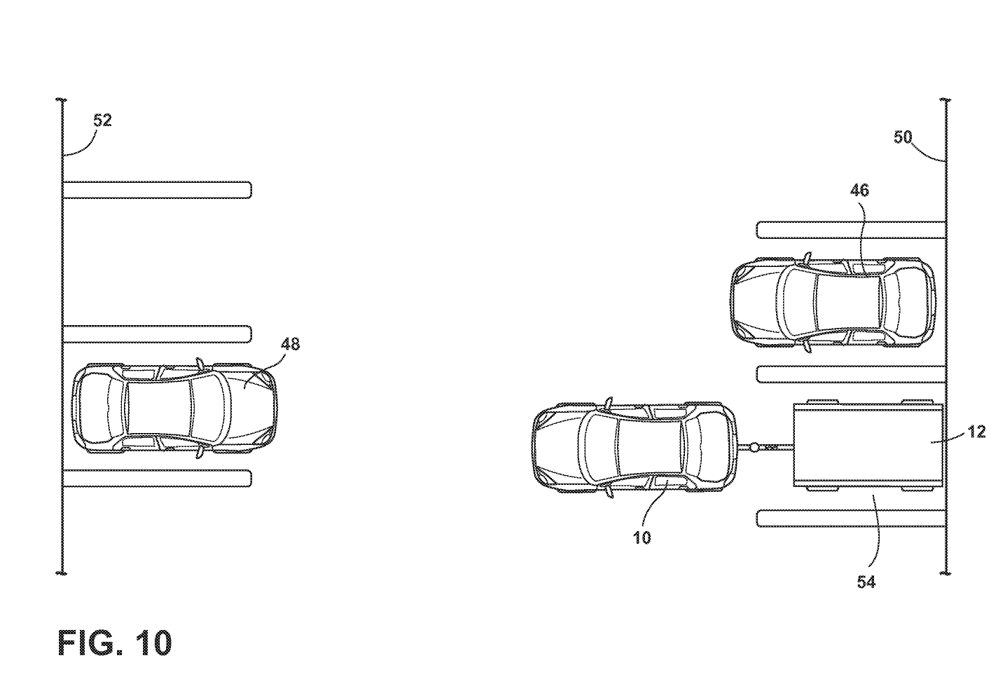

Throughout the backing maneuver, the driver may switch between views on the touchscreen display 58. The views may be representative of images captured by one or more of cameras C1-C6. Once the vehicle 10 and trailer 12 are positioned inside the target space (e.g., 56, FIG. 10), the driver is instructed to stop the vehicle 10 (e.g., depress brake pedal 14) at step 200. In determining when to stop the vehicle 10, the backup assist system 40 may rely on the relative distances of the contiguous lane makers (e.g., lane markers L1 ad L2) and neighboring objects (e.g., vehicle 46 and curb 50) to the vehicle 10 and trailer 12. Such distances may be measured using the sensing system 28 and/or the imaging system 34. After the vehicle 10 has been stopped, the driver may place the vehicle 10 in park at step 210, thereby completing the backing maneuver.

Accordingly, a system and method for backing a vehicle and trailer into a target space have been described herein through the employ an auto-steer maneuver. As a result, the process of backing a vehicle and trailer is greatly simplified.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A system for backing a vehicle and trailer, comprising:
an imaging system configured to detect contiguous lane markers while imaging an operating environment of the vehicle and trailer;
a user interface configured to display the contiguous lane markers in relation to the vehicle and trailer and enable a user to select a target space bounded by the contiguous lane markers; and
a backup assist system configured to determine a steering trajectory into the target space.

2. The system of claim 1, wherein the imaging system comprises a plurality of imagers, each disposed on one of the vehicle and the trailer.

3. The system of claim 1, wherein the user interface comprises a display configured to show a view of the vehicle, trailer, and contiguous lane markers.

4. The system of claim 3, wherein the display is configured to register at least one touch event for selecting the target space.

5. The system of claim 1, further comprising a sensing system configured to detect objects neighboring the vehicle and trailer.

6. The system of claim 1, wherein the backup assist system determines the steering trajectory based on information received from a GPS system, the imaging system, a sensing system, or a combination thereof.

7. The system of claim 1, wherein the backup assist system is further configured to automatically steer the vehicle while a backing maneuver is executed into the selected target space.

8. A system for backing a vehicle and trailer, comprising:
an imaging system configured to detect contiguous lane markers while imaging an operating environment of the vehicle and trailer; and
a backup assist system configured to determine a steering trajectory into a target space bounded by contiguous lane markers, wherein the backup assist system is further configured to automatically steer the vehicle while a backing maneuver is executed into the selected target space.

9. The system of claim 8, further comprising a user interface configured to display the contiguous lane markers in relation to the vehicle and trailer and enable a user to select the target space.

10. The system of claim 9, wherein the user interface comprises a display configured to show a view of the vehicle, trailer, and contiguous lane markers.

11. The system of claim 10, wherein the display is configured to register at least one touch event for selecting the target space.

12. The system of claim 8, wherein the imaging system comprises a plurality of imagers, each disposed on one of the vehicle and the trailer.

13. The system of claim 8, further comprising a sensing system configured to detect objects neighboring the vehicle and trailer.

14. The system of claim 8, wherein the backup assist system determines the steering trajectory based in part on information received from GPS system, the imaging system, a sensing system, or a combination thereof.

15. A method for backing a vehicle and trailer, comprising the steps of:
imaging an operating environment of the vehicle and trailer;
analyzing captured images to detect contiguous lane markers;
displaying contiguous lane markers on a user interface; and
selecting a target space bounded by contiguous lane markers.

16. The method of claim 15, wherein the user interface is configured to display the contiguous lane markers in relation to the vehicle and trailer.

17. The method of claim 16, wherein the user interface comprises a display configured to show a view of the vehicle, trailer, and contiguous lane markers.

18. The method of claim 17, wherein the display is configured to register at least one touch event for selecting the target space.

19. The method of claim 15, wherein the step of determining a steering trajectory comprises receiving information from a GPS system, an imaging system, a sensing system, or a combination thereof.

20. The method of claim 15, further comprising the steps of determining a steering trajectory into the selected target space and automatically steering the vehicle while executing a backing maneuver into the selected target space.
